(19) United States
(12) Patent Application Publication
(10) Pub. No.: US 2005/0235048 A1
(43) Pub. Date: Oct. 20, 2005

(54) Exchanging multimedia data via a communications device

(76) Inventors: Jose Costa-Requena, Helsinki (FI); Inmaculada Espigares, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/828,543

(22) Filed: Apr. 20, 2004

(51) Int. Cl. G06F 15/16

(52) U.S. Cl. 709/219

(57) ABSTRACT

Exchanging multimedia data between a multimedia device and a network involves digitally coupling a communications device to the multimedia device. A profile of the communications device is stored on a data store accessible via the network. The profile describes multimedia capabilities of the communications device, the profile adapted to include a description of multimedia capabilities of the multimedia device. The profile is accessed for purposes of formatting the multimedia data via a network entity. The multimedia data is formatted via the network entity based on the profile to be compatible with the multimedia device. The multimedia data is exchanged between the multimedia device and the network via the communications device.

### FIELD OF THE INVENTION

This invention relates in general to communications devices, and more particularly to communications devices configured for exchanging multimedia data.

### BACKGROUND OF THE INVENTION

Mobile communications devices such as cell phones are gaining wider acceptance due to the capabilities being added to such devices. Far from being simple voice communications tools, modern cell phones and related mobile technologies have staked out an important niche in the growing field of personal digital communications.

One factor that is expected to increase the popularity of mobile devices is the development of third generation (3G) technologies. The designation 3G refers to a collection of standards and technologies that can be used in the near future to enhance performance and increase data speed on cell phone networks. In particular, 3G is an International Telecommunication Union (ITU) specification for the third generation of mobile communications technology. A 3G cell phone would, in theory, be compatible with the 3G languages or standards which support enhanced data speeds.

The 3G infrastructure aims to provide packet-switched data to a handheld terminal with data bandwidth measured in hundreds of Kbits/sec. It is intended that 3G will work over wireless air interfaces such as Code Division Multiple Access (CDMA), Wideband CDMA (W-CDMA), and the Time Division Multiple Access (TDMA) based General Packet Radio Service (GPRS). The latter interface is included in the Enhanced Data for GSM, Environment (EDGE) air interface which has been developed specifically to meet the bandwidth needs of 3G cell phones.

One motivation behind the adoption of 3G is the desire to provide digital multimedia content to mobile users. For example, the use of Multimedia Messaging (MMS) allows mobile device users to send and receive messages with a rich combination of media elements: text, image, sound and video. Thus, the availability of 3G technologies will allow users to access content that was previously only practical to access using high-speed wired links such as Digital Subscriber Line (DSL) and cable modems.

Future 3G devices may also include features that allow communication with other consumer electronics devices. For example, a standard known as Universal Plug and Play™ (UPnP) provides a way for disparate processing devices to exchange data. The UPnP standard includes standards for service discovery, and is mainly targeted for proximity or ad hoc networks. Various contributors publish UPnP device and service descriptions, thus creating a way to easily connect devices and simplifying the implementation of networks. It is the goal of UPnP that the home electronics be able to interact to further the usefulness of such devices. Since a 3G communications device can also typically process data, it is possible for such devices to communicate via UPnP networks.

Because 3G mobile communications devices can provide wireless high-speed data access, these devices can provide additional benefits and uses besides acting as an end-user of multimedia data. The combination of portability and high-bandwidth will make such devices indispensable, both in and away from the user's homes. However, providing additional capabilities via mobile communications devices may require adapting the devices in ways that may not have been envisioned in the design of mobile communications architectures.

### SUMMARY OF THE INVENTION

The present disclosure relates to a system, apparatus and method for exchanging multimedia data between a multimedia device and a network. In accordance with one embodiment of the invention, a method involves digitally coupling a communications device to the multimedia device. A profile of the communications device is stored on a data store accessible via the network. The profile describes multimedia capabilities of the communications device, and the profile is adapted to include a description of multimedia capabilities of the multimedia device. The profile is accessed for purposes of formatting the multimedia data via a network entity. The multimedia data is formatted via the network entity based on the profile to be compatible with the multimedia device. The multimedia data is exchanged between the multimedia device and the network via the communications device.

In more particular embodiments of the invention, the multimedia device may include at least one of a television, and audio system, and a digital media center. The profile may include an XML formatted document, such as a User Agent Profile. Storing the profile may involve updating the profile using a Profile-Diff header in a message sent to the data store. The data store may include a CC/PP repository. In one arrangement, the network entity includes a Multimedia Messaging Service Center (MMSC).

The method may also involve uncoupling the communications device from the multimedia device and updating the profile on the data store to remove the description of multimedia capabilities of the multimedia device. In one configuration, the communications device includes a wireless mobile terminal, such as a cellular phone. The communications device may be coupled to the multimedia device via a Universal Plug and Play (UPnP) network. The communications device may be configured to operate as an Internet Gateway Device for the UPnP network, and the UPnP network may include a wireless UPnP network.

In another embodiment of the present invention, a computer-readable medium has instructions stored which are executable by a communications device that is coupled to a network and a multimedia device. The instructions are executable for performing steps that include determining multimedia capabilities of the multimedia device and storing, on a data store accessible via the network, a profile of the communications device that describes multimedia capabilities of the communications device. The profile is adapted to include a description of multimedia capabilities of the multimedia device. The steps include exchanging multimedia data between the multimedia device and the network. The multimedia data is formatted at a computing arrangement on the network in a format compatible with the multimedia device based on the profile accessed by the computing arrangement via the data store.

In another embodiment of the present invention, a system includes a multimedia device having a data interface and is capable of handling multimedia data exchanged via the data interface. The system further includes a network having a data store configured to store capabilities profiles and a computing arrangement configured to access profiles on the data store and format multimedia data based on the capabilities profiles. A communications device is coupled to the network. The communications device includes a data interface configured to exchange multimedia data with the data interface of the multimedia device and a processor coupled to a memory and the data interface. The memory contains instructions configured to cause the processor to determine multimedia capabilities of the multimedia device and store, on a data store accessible via the network, a profile of the communications device. The profile describes multimedia capabilities of the communications device and is adapted to include a description of multimedia capabilities of the multimedia device. The instructions also cause the processor to transfer multimedia data between the multimedia device and the network. The multimedia data is formatted at a computing arrangement on the network in a format compatible with the multimedia device based on the profile accessed by the computing arrangement via the data store.

In another embodiment of the present invention, a communications device includes a network interface configured to exchange data over a network. A digital interface of the device is configured to exchange multimedia data with a multimedia device. The device includes a processor coupled to a memory, the network interface, and the digital interface. The memory contains instructions configured to cause the processor to 1) determine multimedia capabilities of the multimedia device; 2) store, on a data store accessible via the network, a profile of the communications device that describes multimedia capabilities of the communications device, the profile adapted to include a description of multimedia capabilities of the multimedia device; and 3) transfer multimedia data between the multimedia device and the network. The multimedia data is formatted at a computing arrangement on the network so as to be compatible with the multimedia device based on the profile accessed by the computing arrangement via the data store.

In another embodiment of the present invention, a system for exchanging multimedia data between a network and a multimedia device includes 1) means for determining a multimedia capability of the multimedia device; 2) means for storing, on a data store accessible via the network, a profile including a description of multimedia capabilities of the multimedia device; 3) means for accessing the profile for purposes of formatting the multimedia data; 4) means for formatting the multimedia data for the multimedia device based on the profile; and 5) means for exchanging data between the network and the multimedia device via a communications device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates a system for multimedia data transfers according to embodiments of the present invention;

FIG. 2 illustrates a GSM system for multimedia data transfers according to embodiments of the present invention;

FIG. 3 illustrates a data exchange sequence for peer-to-peer multimedia exchanges according to embodiments of the present invention;

FIG. 4 illustrates a data exchange sequence for server-based multimedia exchanges according to embodiments of the present invention; and

FIG. 5 illustrates a communications device configured for multimedia relaying according to embodiments of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a way of providing multimedia data to multimedia devices via communications devices such as mobile terminals. The communications device maintains a profile that is stored on a network-accessible data store, and the profile is updated to include a capabilities description of the multimedia device. The profile may be accessed via a network entity for purposes of sending multimedia data targeted for the multimedia device. The multimedia data is formatted to be compatible with the multimedia device and exchanged between the multimedia device and the network entity via the mobile communication device.

The present invention is applicable in any type of communication systems and networks where multimedia data transfers are employed. In order to facilitate an understanding of the invention, the present invention is described in the context of a 3G cellular network utilizing standards for mobile device developed by the Wireless Application Protocol (WAP) Forum and World Wide Web Consortium (W3C).

The WAP Forum is focused on enabling advanced services and applications on mobile wireless devices, such as cellular telephones. The W3C is dedicated to leading and advancing the development of the World Wide Web (WWW), which includes bringing Internet and WWW technologies to digital cellular phones and other wireless devices. Both the W3C and WAP Forum are working to enable the delivery of sophisticated information and services to mobile wireless terminals.

The services provided such by WAP and W3C protocols may be significantly enhanced through the higher bandwidth available over 3G networks. This includes the ability to deal with digital multimedia. Multimedia typically refers to graphics, video, and sound, although those skilled in the art will appreciate that multimedia may encompass many forms of digital data that can be presented in a user perceivable form, such as animations, sensor inputs/outputs, biometrics, mechanical device inputs/outputs, etc. The concepts described herein are not limited to any particular form of multimedia. The multimedia may be presented as a data blocks (e.g., files) or continuous streams of data. Generally the multimedia may originate from an analog device (e.g., sensor of a video camera) or be purely digital (e.g., created on a computer). The multimedia data may be transferred and manipulated digitally, and may be converted into a user perceivable form via digital to analog conversion.

Most 3G mobile devices can take advantage of multimedia using built-in multimedia handling devices such as microphones, speakers, liquid crystal displays (LCD), built-in digital cameras, and the like. Given the high-bandwidth networking capabilities inherent in 3G devices, it is possible that these and similar devices may be able to exchange multimedia data with other devices that also handle multimedia. This is particularly true in the home and office environments, where multimedia handling electronics are becoming ubiquitous.

Mobile device typically include facilities for accessing cellular radio networks for transferring voice and data. This is the typical path for receiving multimedia data from the Internet or from other mobile device users. Mobile devices may include additional data interfaces, such as short range wireless data access (e.g., Bluetooth, IEEE 802.11 wireless local area network), wired data access (e.g., Universal Serial Bus, Ethernet, IEEE 1394 “Firewire”, powerline networking), infrared data access, etc. Therefore a mobile device may accept multimedia data from these additional interfaces as well as sending multimedia data to those interfaces.

It will be appreciated that the multimedia capabilities will vary considerable among various devices. For example, a video image or Web page designed to display in a cell phone LED display will not likely be optimally configured for viewing on a wide-screen plasma television. Also, the multimedia data utilized by the cell phone may not be encoded in a format that is recognizable by the plasma television, since mobile devices often use specialized data formats. Therefore, in order to deal with potential conflicts in capabilities when transferring multimedia data between various user devices, a way is needed to assure the multimedia data format (e.g., codec) is compatible with the end device, and also to present the data in a configuration (e.g., dimension, resolution) optimal for the end device.

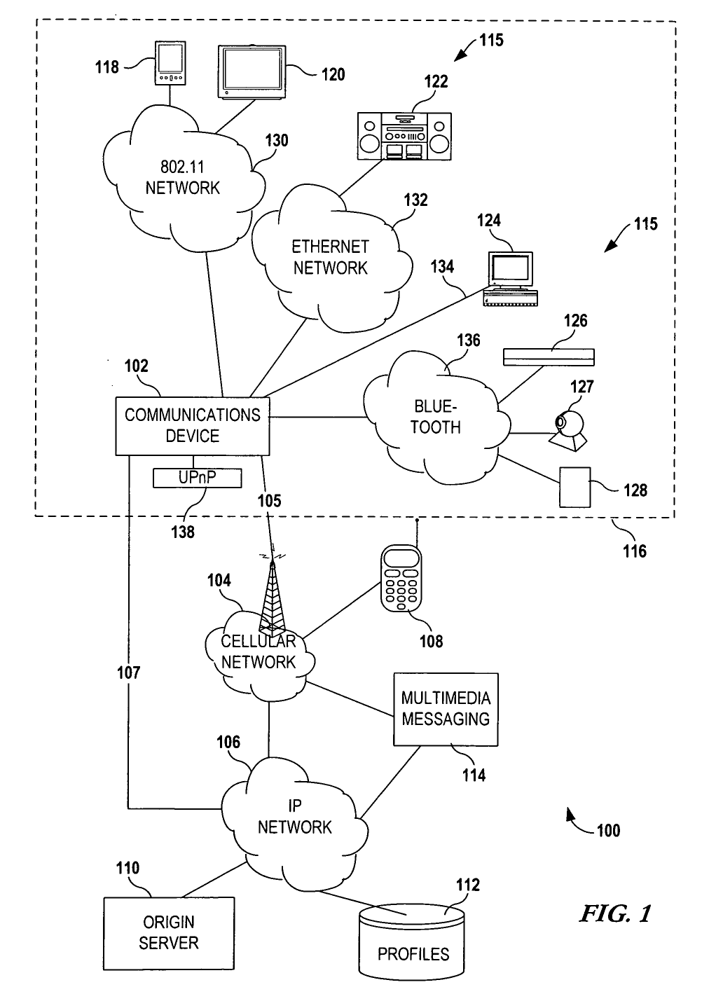

An example system 100 for providing functional and optimal multimedia transfers between devices according to various embodiments of the present invention is shown in FIG. 1. The system 100 includes a communications device 102 that may be configured to communicate over a wireless network 104 as illustrated by path 105. The communications device 102 may also be able to directly communicate with an Internet Protocol (IP) network 106 as indicated by path 107.

The communications device 102 may be a telephone, personal digital assistance, portable computer, or any other device capable of remote data communications. The illustrated wireless network 104 is a cellular network, although it will be appreciated the concepts described in relation to a cellular network may also apply to other types of wired and wireless data communications mediums accessible by the communications device 102, including satellite networks, wired/optical networks, ad-hoc meshed wireless networks, line-of-sight wireless Internet access, etc.

The wireless network 104 may be any digital cellular network known in the art, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. The wireless network 104 may be coupled to other networks, such as the IP network 106. The IP network 106 may include a Global Area Network (GAN) such as the Internet, one or more Wide Area Networks (WAN), Local Area Networks (LAN), etc.

The communications device 102 may engage in multimedia data exchanges with various entities of the networks 104, 106. These entities include other wireless terminals/devices 108 for providing peer-to-peer multimedia data and an origin server 110 (e.g., a Web server) for providing server-based multimedia data. The multimedia data may be provided at the request of the mobile device 102, or the multimedia data may be “pushed” to the device 102 by another entity. For example, the wireless terminal 108 may attempt to send a picture or video stream to the communications device 102. The user of the communications device 102 will be notified of this request and have the option to request or decline the message. If the user accepts, the multimedia data in the message will be provided to the communications device 102 over the network 104.

Providing multimedia data to a wide variety of communications devices, particularly mobile devices, requires adapting the data to the requirements of particular devices. Since mobile devices often work with a limited amount of processing power, bandwidth, and storage, the devices may be reliant on a small set of multimedia formats. These formats may be incompatible with formats used by other mobile devices, as well as non-mobile devices such as desktop computers. In order to account for this, the system 100 may include ways of creating and accessing device profiles and tailoring data based on those profiles. The profiles may be maintained in a commonly accessible profile database 112. The profile database 112 may be accessed by data providers such as the origin server 110 when formatting data targeted for the communications device 102.

The profile database 112 may be accessed by an intermediate multimedia processing device such as a multimedia messaging server 114. The multimedia messaging server 114 acts as a message transfer server for providing multimedia to mobile devices. The multimedia messaging server 114 may work with messaging protocols that operate to inform users of incoming multimedia data. The multimedia messaging server 114 may also transcode multimedia data. Transcoding involves changing various properties of multimedia streams and/or files, including encoding format, image size, image resolution, color depth, audio channels, anti-aliasing, de-interlacing, etc.

The use of the profile database 112 and the multimedia messaging server 114 allows a wide variety of devices to exchange multimedia data without the individual devices having to deal with hardware and software requirements at the other end of the communications. Multimedia communications can be routed through the multimedia messaging server 114, which can tailor the data based on the end-user's profile in the profile database 112.

In addition to exchanging multimedia data over external networks 104, 106, the communications device 102 may also utilize additional data interfaces to interact with multimedia devices 115 in a local environment 116. The local environment 116 typically includes a home or office, although it will be appreciated that other environments may have multimedia devices 115 with which to interact, including automobiles, airplanes, boats, public wireless hotspots, etc. The mobile device 102 may be configured to interact with devices 115 such as personal digital assistants (PDAs) 118, televisions 120, audio systems 122, computers 124, digital media centers 126 (e.g., set-top boxes, MP3 jukeboxes, personal video recorders, etc.), cameras 127, and other devices, represented by generic multimedia device 128.

The mobile device 102 may communicate with devices 115 in the local environment 116 via wired or wireless data interfaces using any data transfer mechanism known in the art. Commonly used data transfer interfaces/mechanisms used include IEEE 802.11 wireless local area networks (WLAN) 130, Ethernet networks 132, Bluetooth networks 134, and direct wired connections 136 (e.g., USB, Ethernet, IEEE 1394, powerline networking, serial/parallel data connections, etc). The communications device 102 may communicate with other devices using any known protocol. In particular, the communications device 102 may include a universal plug-and-play (UPnP™) module 138. The UPnP architecture offers peer-to-peer network connectivity of many forms of electronic devices. The UPnP architecture leverages TCP/IP and other Web technologies to enable proximity networking in addition to control and data transfer among networked devices. UPnP supports zero-configuration networking and automatic discovery, allowing a device to dynamically join networks, obtain an IP address, announce its name, convey its capabilities upon request, and learn about the presence and capabilities of other devices.

It will be appreciated that, even though there is appreciable variation of multimedia capabilities between different communications devices 102, 108, the multimedia capabilities of devices in the local environment 116 may be even more diverse. For example, assume the user has a communications device 102 (e.g., cell phone) configured to send incoming pictures and sound to the user's television 120. Although the television 120 may be able to accept data streams encoded using digital audio/video formats such as MPEG-2, MP3, Windows® Media Video (WMV), and Windows® Media Audio (WMA), this may not be the native format provided by the phone 102. In another example, assuming the television 120 can interpret the image format of an incoming picture (e.g., picture taken from a camera phone), when the picture arrives, it may be scaled for the typically small readout on the mobile terminal 102. Thus the image could appear as only a postcard-size image on a large television display, and would likely be of little use to a user sitting on his or her couch.

Therefore, in a system according to embodiments of the present invention, the communications device 102 maintains a profile on the profile database 112 that includes multimedia characteristics for any devices to which the communications device 102 may forward multimedia data. Similarly, the communications device 102 may use this profile for dealing with any data originating from another device in the local environment 116. For example, the communications device 102 may be able to send to another mobile terminal 108 images from the camera 127. The communications device 102 can update its profile in the profile database 112 to include the formats it can provide to other terminals via a multimedia messaging server 114.

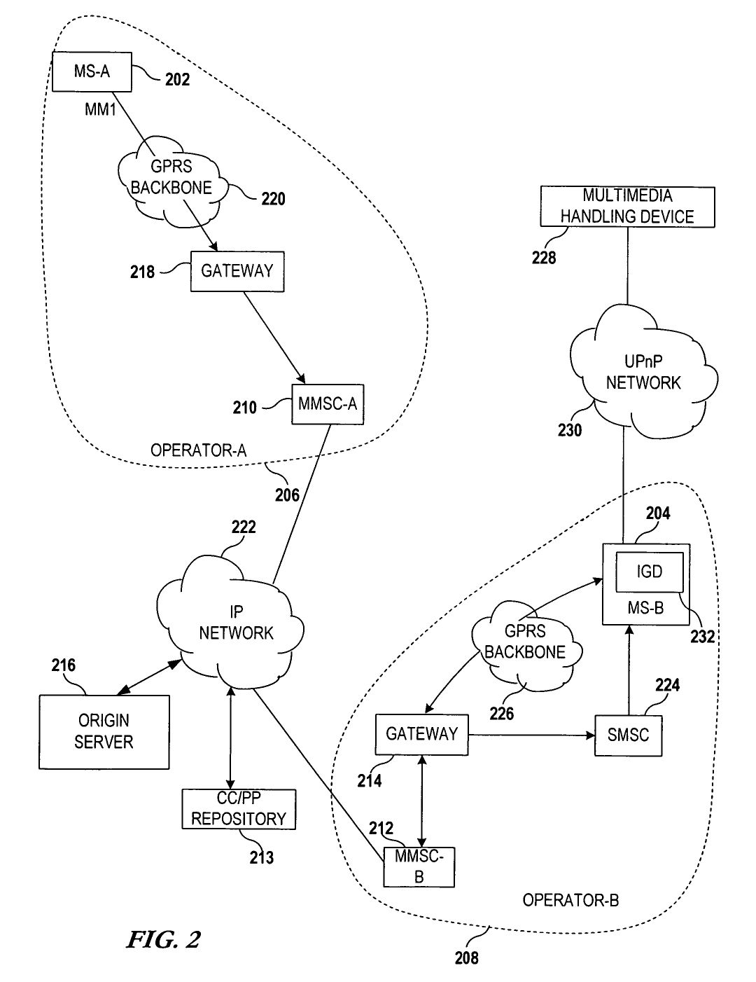

The system illustrated in FIG. 1 may be implemented using a wide variety of data communications mechanisms known in the art. The interactions between the communications device 102 and other network elements in using profiles to format multimedia content is independent of any particular technical implementation. However, a more particular example of a system of exchanging multimedia data according to embodiments of the present invention is illustrated in FIG. 2. For purposes of illustration, FIG. 2 is described in the context of a General Packet Radio System (GPRS) mobile communications network. GPRS is a packet-switched service for GSM that mirrors the Internet model and enables seamless transition towards 3G networks. GPRS thus provides actual packet radio access for mobile GSM and time-division multiple access (TDMA) users, and is ideal for Wireless Application Protocol (WAP) services.

The GPRS networks shown in FIG. 2 may support messaging services, such as Short Message Service (SMS) and Multimedia Messaging Service (MMS). These messaging technologies are “store-and-forward” message services that allow mobile subscribers to exchange messages with other mobile subscribers. SMS allows for communication of text messages between device users. Messages sent by a source device are received by an SMS Center (SMSC) that provides the store-and-forward functionality, and is responsible for delivering the message(s) to the destination device. The SMSC stores the message until the destination device is available, at which time it forwards the message to the destination, removes it from the SMSC, and notifies the sender that the message has been forwarded.

MMS, also based on the store-and-forward service model, is similar to SMS in the manner that messages are communicated. However, unlike SMS, MMS is not limited to text messages, and can include images, video, audio, or other rich content instead or in addition to text. In sending multimedia messages, the destination address used may be the recipient's public number such as the Mobile Station Integrated Services Digital Network Number (MSISDN), or may be an e-mail address. Depending on the addressing scheme employed, the messages will be routed differently; e.g., a message sent to an MSISDN will be routed to the recipient, while a message routed to an e-mail address will be routed directly to the e-mail server (e.g., SMTP) that in turn handles the delivery.

MMS messages are routed by way of MMS Centers (MMSC). For example, where Mobile Station-A (MS-A) 202 of operator network 206 sends an MMS message targeted for MS-B 204 associated with another operator network 208, MMSC-A 210 and MMSC 212 will be involved. The MMSCs 210, 212 may be used for storing, forwarding, and formatting multimedia data for mobile stations.

Users may create an MMS message using a template that specifies the relative position of any multimedia elements within it. They can send the message to either a phone number or email address. The message is sent to the user's MMSC using the WAP PUT command. The MMS can then either be sent to a phone (via a notification message) or translated into a multi-part email and sent to the recipient's email account.

The MMSCs 210, 212 may support multimedia transports in “batch” and “streaming” modes. In batch mode, the entire message is stored and transferred to software (or “user agent”) on the end user's device. In streaming mode, the message is rendered “on the fly” by the user agent as it arrives. For both batch and streaming transport modes, the MMSCs 210, 212 may provide content adaptation.

Content adaptation refers to determining of capabilities of user agents and adapting the multimedia sent to user agent based on those capabilities. The MMSCs 210 may adapt content by transcoding and other data manipulation techniques. The determination of the end user capabilities in the system of FIG. 2 is based on a framework known as User Agent Profile (UAProf). UAProf is based on the W3C Composite Capabilities/Preferences Profile (CC/PP) specification.

The UAProf specification is a WAP extension used to enable the communications of a profile, also referred to as Capability and Preference Information (CPI), between WAP clients, intermediate network points, and origin servers. The components and attributes that devices may convey within the CPI may include hardware characteristics (screen size, color capabilities, image capabilities, manufacturer, etc.), software characteristics (operating system vendor and version, list of audio and video encoders, etc.), application/user preferences (browser manufacturer and version, markup languages and versions supported, scripting languages supported, etc.), WAP characteristics (WML script libraries, WAP version, etc.), and network characteristics (bearer characteristics such as latency and reliability, etc.).

The CPI are published on a public repository, such as the CC/PP repository 213 in FIG. 2. The CPI can be represented as XML-formatted documents that use the Resource Description Framework (RDF). RDF is a language for representing information about resources in the World Wide Web. RDF uses simple statements about resources that are represented as a graph of nodes and arcs. The statements describe the resources, their properties and values. A WAP client can add and maintain an RDF-formatted CPI by using mechanisms defined in the CC/PP Exchange Protocol. The CC/PP exchanges can be transmitted using Hypertext Transport Protocol (HTTP) and Wireless Session Protocol (WSP).

The CC/PP Exchange Protocol specifies two request header fields, Profile and Profile-Diff, for adding and modifying the CPI. The Profile header can be used to transport one or many Profile identities from the client to the server. This set of Profiles is used to construct the CPI. The Profile-Diff header is used to transport changes to the CPI. This means that the Profile-Diff header is used together with and referenced by the Profile header.

In the example of FIG. 2, the UAProf-aware mobile station 204 may convey its profile information using Profile and Profile-Diff headers upon opening a WSP session. Upon receiving the profile, a WAP gateway 214 that is aware of the UAProf capability responds a positive acknowledgment, informing the mobile station 204 that the CPI is being cached and will be effective for the lifetime of the session. The mobile station 204 may update the CPI at any time during the session lifetime.

While a UAProf-aware session is established, the mobile station 204 may update the active UAProf at any time. To do this, the mobile station 204 transmits a WSP Session Resume message to the WAP gateway 214. The message contains Profile and Profile-Diff headers with the new CPI. All future requests issued on the WSP session will be associated with the newly cached Profile and Profile-Diff headers.

A communications device may also affect the CPI via HTTP. An example partial UAProf update request over HTTP is shown in Listing 1. The first two lines in Listing 1 describe 1) the resource that is being requested by the client (http://localhost/ccpp/html); 2) the method being used to make the request, (GET); and 2) the protocol being used (HTTP/1.1).

The remaining lines of the request in Listing 1 describe the device delivery context. The context is specified using a profile reference and a profile-diff. The profile is referenced via the x-wap-profile line. The alphanumerical value following the profile is known as a profile-diff digest. The “1-” part of the profile-diff digest is the profile-diff sequence number. The remainder of the profile-diff digest is a hash of the corresponding profile-diff. The sequence number is used to indicate the order of the profile-diffs and to indicate which profile-diff the profile-diff digest refers to.

After the profile-diff digest, the next line contains the x-wap-profile-diff. This request header field also has a profile-diff sequence number which indicates that this profile-diff corresponds to the previous profile-diff-digest. The profile-diff itself consists of the XML fragment which is included in the remainder of the request.

When the repository 213 receives an HTTP update request with UAProf request headers, it has to perform profile resolution. Profile resolution involves retrieving the referenced profile(s) and any further profiles referenced via default blocks. It then merges these profiles and the profile-diffs while applying the UAProf resolution rules.

Listing 1

GET /ccpp/html/ HTTP/1.1
Host: localhost
x-wap-profile:

“http://10.0.0.1:8088/ccpp/profiles/
defaults.rdf”, “1-Ab0sq/nuUFEU75vAjKyiHw==”

x-wap-profile-diff:1;<?xml version=“1.0”?>
<RDF xmlns=“http://www.w3.org/1999/02/22-rdf-syntax-ns#”
xmlns:rdf=“http://www.w3.org/1999/02/22-rdf-syntax-ns#”
xmlns:prf=“http://www.wapforum.org/UAPROF/ccppschema-
20000403#”>

<rdf:Description ID=“MyProfile”>

<prf:component>

<rdf:Description ID=“HardwarePlatform”>

<rdf:type resource=“http://www.wapforum.org/

UAPROF/ccppschema-
2000#”/>

<prf:ScreenSize>176x208</prf:ScreenSize>
<prf:Model>7650</prf:Model>
<prf:ScreenSizeChar>15x6</prf:ScreenSizeChar>
<prf:ColorCapable>Yes</prf:ColorCapable>
<prf:BitsPerPixel>12</prf:BitsPerPixel>
. . .

</rdf:Description>

</prf:component>
<prf:component>

<rdf:Description ID=“MMSCharacteristics”>

<rdf:type resource=“http://www.wapforum.org/

profiles/MMS/ccppschema-20010403#”/>

<prf:MmsMaxMessageSize>102400

</prf:MmsMaxMessageSize>

<prf:MmsMaxImageResolution>640x480

</prf:MmsMaxImageResolution>

<prf:MmsVersion>1.0</prf:MmsVersion>
<prf:MmsCcppAccept>

<rdf:Bag>

<rdf:li>image/jpeg</rdf:li>
<rdf:li>image/gif</rdf:li>
<rdf:li>image/png</rdf:li>
<rdf:li>image/vnd.wap.wbmp</rdf:li>
<rdf:li>image/x-bmp</rdf:li>
<rdf:li>audio/amr</rdf:li>
. . .
</rdf:Bag>

</prf:MmsCcppAccept>

</rdf:Description>

</prf:component>

</rdf:Description>

</RDF>

A third party host such as an origin server 216 may issue a request for the CPI of the mobile station 204. The server 216 may issue this request, for example, to generate content that directed for the mobile station 204. Such requests will typically be made to a WAP gateway 214 and/or CC/PP repository 213 using HTTP. For example, the station MS-B 204 may request multimedia data from the origin server 216 using an HTTP GET. The request includes a reference to the UAProf associated with MS-B 204. The origin server 216 can download this profile from the CC/PP repository 213 and format the document returned from the GET in accordance with the profile.

The profile stored in the CC/PP repository 213 may also be used for station-to-station multimedia exchanges. Multimedia data may originate from the sender mobile station MS-A 202 that is operating within the operator-A network 206. The user of MS-A 202 sends an MMS message to the gateway 218 via the GPRS backbone 220. The gateway 218 may represent a Push Proxy Gateway (PPG), WAP gateway, or the like. In accordance with Third Generation Partnership Project (3GPP) standards, the MMS message may be submitted from the MMS user agent of MS-A 202 to the gateway 218. The MMS message may be forwarded from the gateway 218 to the MMSC-A 210 using, for example, an HTTP POST. The HTTP POST includes the MSISDNs of MS-A 202 as well as the recipient MS-B 204 associated with the operator-B network 208.

The MMSC-A 210 sends the MMS message to MMSC-B 212 via the IP network 222. The terminal MS-B 204 is informed of an incoming MMS message by the gateway 214, which is coupled to MS-B 204 via the GPRS backbone 226. This information may be sent from the gateway 214 to a Short Message Service Center (SMSC) 224 via an SMS message, for example. If the user accepts the message, MS-B 204 can perform a fetch function to the gateway 214, which prompts the gateway 214 to retrieve the MMS message. This fetch includes a reference to the UAProf describing the device capabilities of MS-B 204. MMSC-B 212 uses this reference to download the UAProf from the CC/PP repository 213 and prepares the response data in accordance with this UAProf. The gateway 214 may obtain the MMS message using, for example, an HTTP GET function, where after the MMS message may be provided to the targeted recipient MS-B 204.

The multimedia exchanges described above will result in the station MS-B 204 receiving correctly formatted data for that device. However, the station MS-B may be coupled to transfer data to an external multimedia device 228 via, for example, a local UPnP network 230. In particular, the station MS-B 204 may include an Internet Gateway Device (IGD) module 232 that allows the station MS-B 204 to act as an IGD for the UPnP network 230 towards wireless networks (GSM, 3G, UMTS, WAP, etc).

An IGD is an IP addressable device typically residing at the edge of a home or small-business network. An IGD interconnects at least one UPnP LAN with a WAN interface for Internet access. An IGD also provides local addressing and routing services between one or more LAN segments and to and from the Internet. In the example of FIG. 2, the IGD module 232 also acts as a relay for forwarding multimedia data to one or more multimedia devices 228.

In order for the IGD module 232 to correctly present multimedia to the multimedia device 228, the module 232 must determine capabilities of the device 228. The UPnP architecture includes mechanisms for discovery of devices on the network 230 and mechanisms for describing capabilities of those devices. The UPnP discovery protocol utilizes multicast messages that allow a device to advertise its services to control points on the network when the device is added to the network. All devices on the network 230 listen to the standard multicast address for these messages and will respond if any of their embedded devices or services matches the search criteria in the discovery message.

Once devices on the UPnP network 230 have discovered each other, they still have very little knowledge about each other. For learning more about device capabilities, and/or to interact with the device, a description of the device and its capabilities can be retrieved from a Uniform Resource Locator (URL) provided by the device in the discovery message. A UPnP device description is written in XML syntax and is usually based on a standard UPnP Device Template. The formats and usages of UPnP descriptors, as well as the specification of the rest of the UPnP architecture, are provided by the UPnP Forum (www.upnp.org).

The IGD module 232 can use UPnP discovery and description to obtain multimedia capabilities of the multimedia device 228. The UPnP capabilities are used to form a UAProf descriptor that describes capabilities of the multimedia device 228. The station MS-B 204 can publish these capabilities to the CC/PP repository 213 using a Profile-Diff request. Thereafter, when multimedia data is exchanged with the station MS-B 204, the IGD module 232 can query to determine whether the data is destined for the station MS-B 204 or to the multimedia device 228. The IGD 232 can produce a reference to the correct UAProf based on this query, and network elements such as the MMSC-B 212 can use the UAProf to correctly format the multimedia data. If the multimedia data is destined for the multimedia device 228, the station MS-B 204 can forward this data via the IGD module 232 and UPnP network 230.

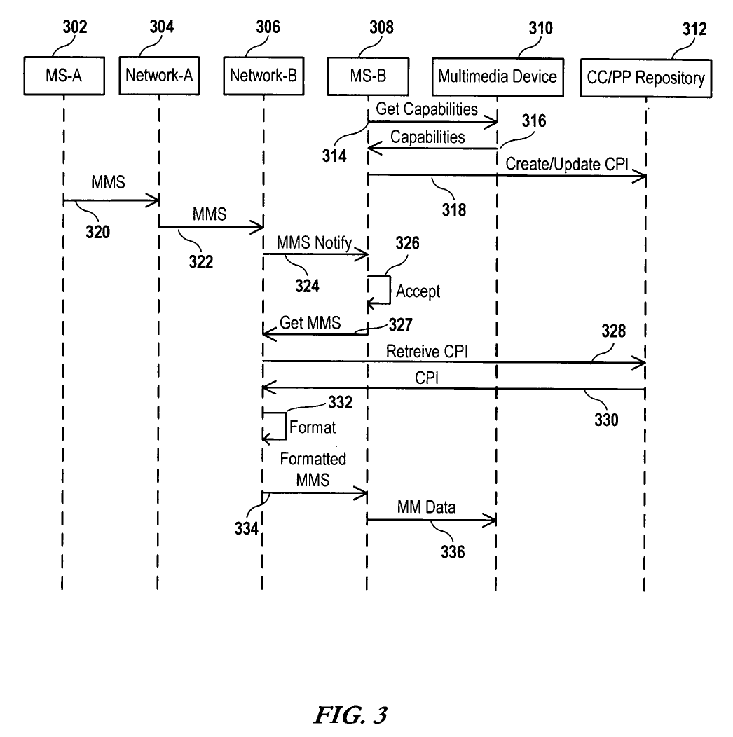

An example message exchange used in providing multimedia to a multimedia device according to embodiments of the present invention is illustrated in FIG. 3. In this scenario, terminal-A 302 and terminal-B 308 are respectively associated with wireless network-A 304 and wireless network-B 306 in an arrangement such as that illustrated in FIG. 2. It may be assumed that network-A 304 and network-B 306 each include the appropriate gateways, MMSCs, and other network entities used to effectuate multimedia messaging between mobile devices. Terminal-B 308 is enabled to connect to and exchange data with multimedia device 310.

When terminal-B 308 first connects to the multimedia device 310, terminal-B 308 request device capabilities 314 using appropriate mechanisms of the interfaces coupling the device 310 and terminal 308. These capabilities 316 are subsequently returned to terminal-B 308. The terminal 308 uses the capabilities to form a CPI in accordance with UAProf, and this profile is communicated to a CC/PP repository 312 using a create/update message 318. An entirely new profile may be created using a Profile header in the message 318, or an existing profile may be updated using a Profile-Diff header in the message 318. In either case, a profile stored on the CC/PP repository 312 now includes capabilities of the multimedia device 310.

Next, the terminal-A 302 initiates the sending of an MMS message 320 via elements of network-A 304, which forward the MMS 322 to elements of network-B 306. Terminal-B 308 then receives a notification 324 of an MMS message, and the terminal 308 takes appropriate action in order to accept 326 the message. The process of accepting 326 the message may involve prompting the user or otherwise determining whether the MMS message will be handled by terminal-B 308 or the multimedia device 310, and choosing the correct UAProf reference based on that choice. Terminal-B 308 then retrieves the MMS message 327, and in the process of retrieving, informs the network element storing the message of the correct profile to use.

The network element (e.g., MMSC) that is storing the MMS data can use the reference contained in the request 327 to send a retrieval message 328 for the CPI from the CC/PP repository 312. The network element of network-B 306 can use the CPI 330 received from the repository 312 to format 332 the MMS. The formatted MMS 334 is then passed to terminal-B 308. Finally, assuming the final destination of the data is the multimedia device 310, terminal-B passes multimedia data 336 based on the MMS to the multimedia device 310. Terminal-B 310 may simply pass the MMS 334 it received directly to the device 310, or the terminal 310 may perform additional operations on the data 336, such as stripping out protocol headers.

It will be appreciated that the data exchanges described in relation to FIG. 3 may be independent of the order presented here, and that some operations may occur in parallel. For example, terminal-B 308 may be arranged to connect to the multimedia device 310 (e.g., using exchanges such as 314, 316, 318) after an MMS notify 324, perhaps as part of the acceptance process 326. It will also be appreciated that the procedures may be adapted to send multimedia data originating at terminal-B 308 to the multimedia device 310. For example, terminal-B 308 may create an MMS based on an internal camera-phone picture, and send the picture in an MMS targeted for itself. Upon retrieval of the MMS, the terminal 308 can indicate the profile of the multimedia device 310, thereby having the MMSC of network-B 306 do the transcoding. In this way, the terminal 308 can transform data targeted for the multimedia device 310 even if the terminal 308 does not have the correct decoders or other required software.

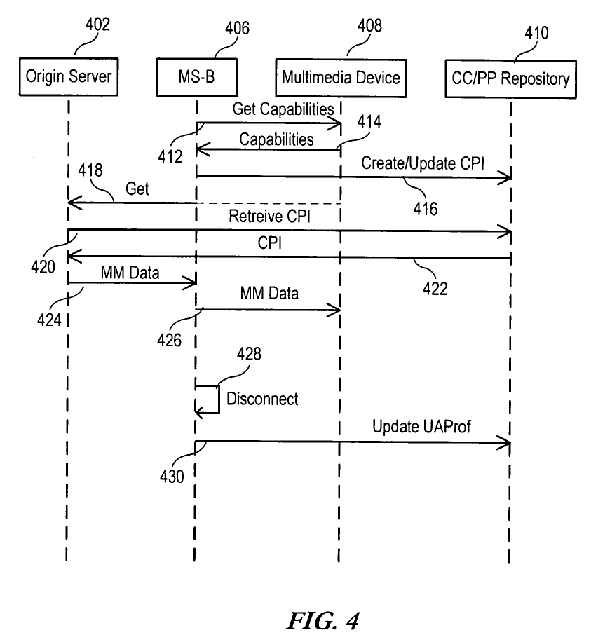

Although terminal-to-terminal communications is one way to transfer multimedia data among mobile devices, this data may also be provided at the request of the terminal itself, such as when requesting an object from a Web server. An example of recipient-initiated multimedia data transfers according to embodiments of the present invention is illustrated in FIG. 4. In this scenario, terminal-B 406 has access to an origin server 402 in an arrangement such as that illustrated in FIG. 2. Terminal-B 406 is also enabled to connect to and exchange data with multimedia device 408.

As in FIG. 3, terminal-B 406 requests device capabilities 412 of the multimedia device 408. These capabilities 414 are returned to terminal-B 406, which use the capabilities to form a profile in accordance with UAProf. This profile is communicated to a CC/PP repository 410 using a create/update message 416. The profiles stored on the CC/PP repository 410 now include capabilities of the multimedia device 408.

A user-initiated request 418 is sent to the origin server 402. This request 418 is sent via terminal-B 406, and may originate from terminal-B 406. However, the request 418 may also originate from the multimedia device 408, as indicated by the dashed line on the request 418. This may occur, for example, when the multimedia device 408 includes a user input device (e.g., mouse) that enables it to control actions of terminal-B 406 via a graphical user interface (GUI) of the device 408 or similar means. Whatever the origination of the request 418, the request 418 will include a profile reference with the request. The profile reference can be used to get a CPI of the multimedia device 408.

The origin server 402 can use the reference contained in the request 418 to retrieve 420 the CPI from the CC/PP repository 410. The origin server 402 receives the CPI 422 which is used to provide properly formatted multimedia data 424 that is passed to terminal-B 406. Terminal-B 406 then passes multimedia data 426 based on the data 424 to the multimedia device 408.

The diagram of FIG. 4 also illustrates the step of updating the CC/PP repository 410 when terminal-B 406 is no longer connected to the multimedia device 408. Terminal-B disconnects 428 from the device 408, intentionally or otherwise, and then updates 430 the CC/PP repository 410 in order to remove the profile data related to the multimedia device 408.

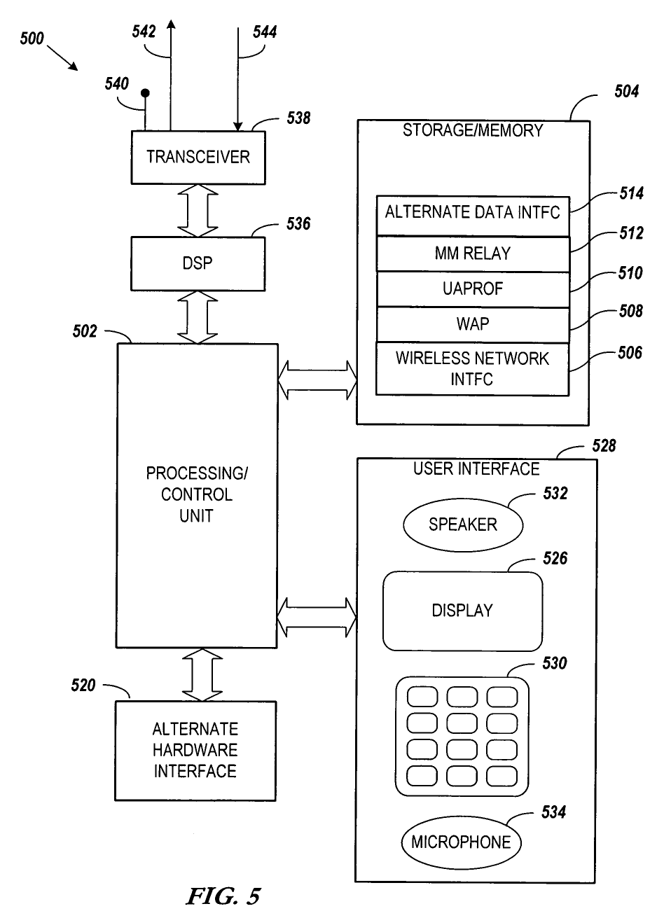

In reference now to FIG. 5, an example of a representative mobile terminal computing environment 500 capable of carrying out operations in accordance with embodiments of the invention is illustrated. Those skilled in the art will appreciate that the exemplary mobile computing environment 500 is merely representative of general functions that may be associated with such mobile devices, and also that landline computing systems similarly include computing circuitry to perform such operations.

The mobile computing arrangement 500 is suitable for processing multimedia data in accordance with embodiments of the present invention. The representative mobile computing arrangement 500 includes a processing/control unit 502, such as a microprocessor, reduced instruction set computer (RISC), or other central processing module. The processing unit 502 need not be a single device, and may include one or more processors. For example, the processing unit may include a master processor and associated slave processors coupled to communicate with the master processor.

The processing unit 502 controls the basic functions of the mobile terminal. Those functions associated may be included as instructions stored in a program storage/memory 504. In one arrangement, the program storage/memory 504 includes a wireless network interface 506, a WAP protocol stack 508, a UAProf processing module 510, a multimedia relay processing module 512, and an alternate data interface 514.

The wireless network interface 506 includes drivers and other software components for communicating with circuitry coupled to the processing/control unit 502 for performing wireless data transmissions. This circuitry may include a digital signal processor (DSP) 536 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 538, generally coupled to an antenna 540, transmits the outgoing radio signals 542 and receives the incoming radio signals 544 associated with the wireless device.

The WAP protocol stack 508 contains the various levels of protocol handlers for interfacing with WAP networks. This may include protocol handlers for Wireless Application Environment (WAE), Wireless Session Protocol (WSP), Wireless Transaction Protocol (WTP), Wireless Transport Layer Security (WTLS), and Wireless Datagram Protocol (WDP).

The UAProf processing module 510 includes various functional modules used to create, modify, and maintain UAProf descriptors. The UAProf processing module may handle various transactions with a CC/PP repository in maintaining profiles. The UAProf processing module 510 may interact with the multimedia relay processing module 512 in translating external multimedia capability formats to UAProf formats.

The multimedia relay processing module 512 contains the logic necessary to exchange multimedia data between the wireless network interface 506 and the alternate data interface 514. The alternate data interface 514 includes drivers and other software components needed to communicate over an alternate hardware interface 520 coupled to the processing/control unit 502. The alternate hardware interface 520 can be data-coupled to some manner of external multimedia device as described herein.

The multimedia relay processing module 512 may include low-level protocol functionality, such as that required to act as a UPnP IGD, or utilize other protocols associated with a multimedia device. The relay processing module 512 may also include application level functionality, such as configuration control panels and user interface elements used to control the flow of multimedia data to various devices.

The program storage/memory 504 may also include operating systems for carrying out functions and applications associated with multimedia functions on the mobile terminal. The program storage 504 may include one or more of read-only memory (ROM), flash ROM, programmable and/or erasable ROM, random access memory (RAM), subscriber interface module (SIM), wireless interface module (WIM), smart card, or other removable memory device.

In one embodiment of the invention, the program modules associated with the storage/memory 504 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The processor 502 is also coupled to user-interface 528 elements associated with the mobile terminal. The user-interface 528 of the mobile terminal may include, for example, a display 526 such as a liquid crystal display, a keypad 530, speaker 532, and microphone 534. These and other user-interface components are coupled to the processor 502 as is known in the art. Other user-interface mechanisms may be employed, such as voice commands, switches, touch pad/screen, graphical user interface using a pointing device, trackball, joystick, or any other user interface mechanism.

The mobile computing arrangement 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Hardware, firmware, software or a combination thereof may be used to perform the various functions and operations described herein of a distributed-computation program. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a distributed-computation system, apparatus, and method in accordance with the present invention.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A method of exchanging multimedia data between a multimedia device and a network, comprising:
digitally coupling a communications device to the multimedia device;
storing, on a data store accessible via the network, a profile of the communications device describing multimedia capabilities of the communications device, the profile adapted to include a description of multimedia capabilities of the multimedia device;
accessing the profile for purposes of formatting the multimedia data via a network entity;
formatting the multimedia data via the network entity based on the profile so that the data is compatible with the multimedia device; and
exchanging the multimedia data between the multimedia device and the network via the communications device.

2. The method of claim 1, wherein the multimedia device comprises at least one of a television, a digital media center, and an audio playback device.

3. The method of claim 1, wherein the profile comprises an XML formatted document.

4. The method of claim 3, wherein the profile comprises a User Agent Profile.

5. The method of claim 1, wherein the storing the profile comprises updating the profile using a Profile-Diff header in a message sent to the data store.

6. The method of claim 1, wherein the data store comprises a CC/PP repository.

7. The method of claim 1, wherein the network entity comprises a Multimedia Messaging Service Center (MMSC).

8. The method of claim 1, further comprising:
uncoupling the communications device from the multimedia device; and
updating the profile on the data store to remove the description of multimedia capabilities of the multimedia device.

9. The method of claim 1, wherein the communications device comprises a wireless mobile terminal.

10. The method of claim 1, wherein the communications device comprises a cellular phone.

11. The method of claim 1, wherein the communications device is coupled to the multimedia device via a Universal Plug and Play (UPnP) network.

12. The method of claim 11, wherein the communications device is configured to operate as an Internet Gateway Device for the UPnP network.

13. The method of claim 12, wherein the UPnP network comprises a wireless UPnP network.

14. A computer-readable medium having instructions stored thereon which are executable by a communications device capable of being coupled to a) a network and b) a multimedia device, for performing steps comprising:
determining multimedia capabilities of the multimedia device;
storing, on a data store accessible via the network, a profile of the communications device that describes multimedia capabilities of the communications device, the profile adapted to include a description of multimedia capabilities of the multimedia device; and
exchanging multimedia data between the multimedia device and the network, the multimedia data formatted by a computing arrangement on the network in a format compatible with the multimedia device based on the profile accessed by the computing arrangement via the data store.

15. The computer-readable medium of claim 14, wherein the multimedia device comprises at least one of a television, a digital media center, and an audio playback device.

16. The computer-readable medium of claim 14, wherein the profile comprises a User Agent Profile.

17. The computer-readable medium of claim 14, wherein the storing the profile comprises updating the profile using a Profile-Diff header in a message sent to the data store.

18. The computer-readable medium of claim 14, wherein the data store comprises a CC/PP repository.

19. The computer-readable medium of claim 14, wherein the steps further comprise updating the profile on the data store to remove the description of multimedia capabilities of the multimedia device in response to uncoupling the communications device from the multimedia device.

20. The computer-readable medium of claim 14, wherein the communications device comprises a wireless mobile terminal.

21. The computer-readable medium of claim 14, wherein the communications device comprises a cellular phone.

22. A system comprising:
a multimedia device having a data interface and capable of handling multimedia data exchanged via the data interface;
a network having a data store configured to store capabilities profiles and a computing arrangement configured to access profiles on the data store and format multimedia data based on the capabilities profiles; and
a communications device coupled to the network comprising,
a data interface configured to exchange multimedia data with the data interface of the multimedia device;
a processor coupled to a memory and the data interface, the memory containing instructions configured to cause the processor to,
determine multimedia capabilities of the multimedia device;
store on the data store a profile of the communications device that describes multimedia capabilities of the communications device, the profile adapted to include a description of multimedia capabilities of the multimedia device;
transfer multimedia data between the multimedia device and the network, the multimedia data formatted by the computing arrangement based on the profile accessed by the computing arrangement via the data store.

23. The system of claim 22, wherein the multimedia device comprises at least one of a television, a digital media center, and an audio playback device.

24. The system of claim 22, wherein the profile comprises a User Agent Profile.

25. The system of claim 22, wherein the storing the profile comprises updating the profile using a Profile-Diff header in a message sent to the data store.

26. The system of claim 22, wherein the data store comprises a CC/PP repository.

27. The system of claim 22, wherein the computing arrangement comprises a Multimedia Messaging Service Center (MMSC).

28. The system of claim 22, wherein the communications device comprises a wireless mobile terminal.

29. The system of claim 22, wherein the communications device comprises a cellular phone.

30. The system of claim 22, wherein the communications device is coupled to the multimedia device via a Universal Plug and Play (UPnP) network.

31. The system of claim 30, wherein the communications device is configured to operate as an Internet Gateway Device for the UPnP network.

32. The system of claim 31, wherein the UPnP network comprises a wireless UPnP network.

33. A communications device, comprising:
a network interface configured to exchange data over a network;
a digital interface configured to exchange multimedia data with a multimedia device;
a processor coupled to the network interface and the digital interface; and
a memory coupled to the processor and containing instructions configured to cause the processor to,
determine multimedia capabilities of the multimedia device;
store, on a data store accessible via the network, a profile of the communications device that describes multimedia capabilities of the communications device, the profile adapted to include a description of multimedia capabilities of the multimedia device; and
transfer multimedia data between the multimedia device and the network, the multimedia data formatted at a computing arrangement on the network so as to be compatible with the multimedia device based on the profile accessed by the computing arrangement via the data store.

34. The communications device of claim 33, wherein the multimedia device comprises at least one of a television, a digital media center, and an audio playback device.

35. The communications device of claim 33, wherein the profile comprises a User Agent Profile.

36. The communications device of claim 33, wherein the storing the profile comprises updating the profile using a Profile-Diff header in a message sent to the data store.

37. The communications device of claim 33, wherein the data store comprises a CC/PP repository.

38. The communications device of claim 33, wherein the communications device comprises a wireless mobile terminal.

39. The communications device of claim 33, wherein the communications device comprises a cellular phone.

40. A system for exchanging multimedia data between a network and a multimedia device, comprising:
means for determining a multimedia capability of the multimedia device;
means for storing, on a data store accessible via the network, a profile including a description of multimedia capabilities of the multimedia device;
means for accessing the profile for purposes of formatting the multimedia data;
means for formatting the multimedia data for the multimedia device based on the profile; and
means for exchanging data between the network and the multimedia device via a communications device.

41. A method of exchanging multimedia data between a multimedia device and a communications device via a network, comprising:
determining multimedia capabilities of the multimedia device via the communications device;
storing a profile of the communications device on a data store coupled to the network, the profile having a description of multimedia capabilities of the communications device and a description of multimedia capabilities of the multimedia device; and
transferring multimedia data between the communications device and the multimedia device via the network, the multimedia data formatted at a computing arrangement to the network so as to be compatible with the multimedia device based on the profile.
